(19) United States
(12) Patent Application Publication
(10) Pub. No.: US 2025/0190911 A1
(43) Pub. Date: Jun. 12, 2025

(54) COMPUTER-READABLE RECORDING MEDIUM STORING WORK PLAN PREPARATION PROGRAM, METHOD FOR PREPARING WORK PLAN, AND INFORMATION PROCESSING DEVICE

(71) Applicant: FUJITSU LIMITED, Kawasaki-shi (JP)

(72) Inventor: Ayano HASOME, Kawagoe (JP)

(73) Assignee: FUJITSU LIMITED, Kawasaki-shi (JP)

(21) Appl. No.: 19/055,307

(22) Filed: Feb. 17, 2025

Related U.S. Application Data
(63) Continuation of application No. PCT/JP2022/039825, filed on Oct. 26, 2022.

(51) Int. Cl. G06Q 10/0631; G05D 1/644; G05D 1/648; G05D 105/20; G05D 107/70; G06Q 10/087

(52) U.S. Cl. CPC G06Q 10/06316; G05D 1/644; G05D 1/6482; G06Q 10/087; G05D 2105/20; G05D 2107/70

(57) ABSTRACT

A recording medium stores a program for causing a computer to execute a process including: under a condition regarding articles, columns including article shelves, and aisles provided between the columns, and a moving body that has a placement space moves on the aisles, moves the aisles, and performs a first work of placing first articles on the moving body from the article shelves, and a second work of placing second articles placed on the moving body on the article shelves, executing, on a work plan in which the moving body performs the first work and the second work on the articles, either a first search of searching for the work plan so as to decrease a total moving distance in a direction or a second search of searching for the work plan so as to decrease the total moving distance between the columns, and dividing the work plan into subplans.

### CROSS-REFERENCE TO RELATED APPLICATION

This application is a continuation application of International Application PCT/JP2022/039825 filed on Oct. 26, 2022 and designated the U.S., the entire contents of which are incorporated herein by reference.

### FIELD

The embodiments discussed herein are related to a work plan preparation program, a method for preparing a work plan, and an information processing device.

### BACKGROUND

A technique for automatically performing picking work is disclosed.

Japanese Laid-open Patent Publication No. 2022-068557 is disclosed as related art.

### SUMMARY

According to an aspect of the embodiments, a non-transitory computer-readable recording medium stores a work plan preparation program for causing a computer to execute a process including: under a condition regarding a plurality of articles, a plurality of columns that each include a plurality of article shelves, and a plurality of aisles provided between the plurality of columns, in which identifiers that indicate correspondence relationships between each of the plurality of articles and each of the plurality of article shelves are assigned, and a moving body that has a placement space intended to place the articles moves on any of the plurality of aisles as an outward path, moves any aisle of the plurality of aisles as a backward path, and performs at least one of a first work of placing a plurality of first articles specified by the identifiers on the moving body from the article shelves, and a second work of placing a plurality of second articles placed on the moving body on the article shelves specified by the identifiers assigned to the second articles, executing, on a work plan in which the moving body performs the first work and the second work on the articles designated from among the plurality of articles, either a first search of searching for the work plan so as to decrease a total moving distance in a direction in which the aisles extend or a second search of searching for the work plan so as to decrease the total moving distance between the plurality of columns, and dividing the work plan found in the search into a plurality of subplans; executing both of the first search and the second search on each of the plurality of subplans; and preparing the work plan by combining results of the first search and the second search for the plurality of subplans.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an outline of an automatic picking work;

FIG. 2 is a diagram illustrating a picking work capable of efficiently performing a pickup work and a return work;

FIG. 3 is a perspective view of an inside of a warehouse;

FIG. 4 is a diagram explaining a layout in a warehouse;

FIG. 5A is a block diagram illustrating an overall configuration of an information processing device, and FIG. 5B is a block diagram illustrating a hardware configuration of the information processing device;

FIG. 6 is a diagram illustrating a held layout;

FIG. 7 is a diagram illustrating orders;

FIG. 8 is a flowchart representing an example of processing executed by the information processing device;

FIG. 9 is a diagram illustrating aisle numbers;

FIG. 10 is a diagram illustrating the number of orders counted;

FIG. 11 is a diagram explaining a V method;

FIG. 12 is a diagram explaining a P method;

FIG. 13 is a diagram explaining the P method;

FIG. 14 is a flowchart representing details of step S3;

FIG. 15 is a flowchart representing details of step S3;

FIG. 16 is a flowchart representing details of step S3;

FIG. 17 is a flowchart representing details of optimization by the V method;

FIG. 18 is a flowchart representing details of step S72;

FIGS. 19A and 19B are diagrams for explaining an example of optimization;

FIGS. 20A and 20B are diagrams for explaining an example of optimization;

FIG. 21 is a diagram for explaining an example of optimization; and

FIGS. 22A and 22B are diagrams for explaining an example of optimization.

### DESCRIPTION OF EMBODIMENTS

In a warehouse or the like in which article shelves each form a line, picking work may be sometimes performed using a traveling machine such as a moving body (automatic guided vehicle (AGV)), for example. However, since the maximum number of articles to be placed in the traveling machine is designated, the number of articles that can be conveyed at one time is limited. In addition, there are an enormous number of article shelves in a large warehouse. Therefore, it is complicated to prepare a work plan for simultaneously performing a pickup work and a return work. Note that this problem is not limited to a case where the traveling machine automatically performs the picking work and can also occur in a case where a worker manually performs the picking work, using a moving body such as a cart.

In one aspect, an object of this case is to provide an information processing device, a method for preparing a work plan, and a work plan preparation program capable of preparing efficient pickup-return work.

Prior to the description of an embodiment, an outline of an automatic picking work will be described.

In a distribution warehouse, stock of diverse products is kept in a large space. In such a distribution warehouse, a plurality of types of products is kept. Each product case containing a plurality of same products is contained in a preset product shelf.

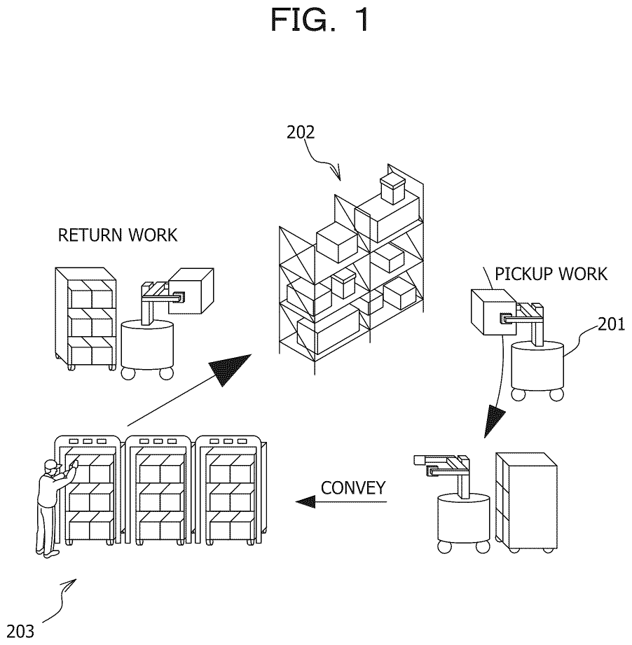

In the picking work for these products, there is a case where a worker picks up the products from the product cases located on the respective product shelves, and there is also a case where a traveling machine (automatic guided vehicle: AGV) automatically picks up the products. Here, a case where the traveling machine automatically picks up the products will be described as an example. For example, as illustrated in FIG. 1, a traveling machine 201 travels to a product shelf 202 containing a product case containing a product for which pickup is designated (hereinafter, a pickup product case) and picks the pickup product case from the product shelf 202. This work will be hereinafter referred to as a pickup work. The traveling machine 201 having the pickup product cases placed in its own placement space conveys and aggregates the pickup product cases in a picking work area 203. In the picking work area 203, the final picking work from the pickup product cases is performed by the worker. The traveling machine 201 conveys the product case after the final picking work has been performed (hereinafter, a return product case) and returns the return product case to the original product shelf 202.

However, since the maximum number of product cases to be placed in the traveling machine 201 is designated, the number of product cases that can be conveyed at one time is limited. In addition, there are an enormous number of product shelves in a large warehouse. Therefore, it is complicated to prepare a work plan for simultaneously performing the pickup work and the return work. If the combination of product cases to be returned and picked up at one time of work and the work sequence are not considered, the work efficiency is rather lowered. Note that the designated maximum number to be placed may be different from the maximum permissible number to be placed in the traveling machine 201. For example, there can be a case where, even if a maximum of seven product cases can be placed in the placement space of the traveling machine 201, a maximum number of six to be placed is designated. In this manner, it is also desired that the work plan preparation scheme can cope with a large-scale problem.

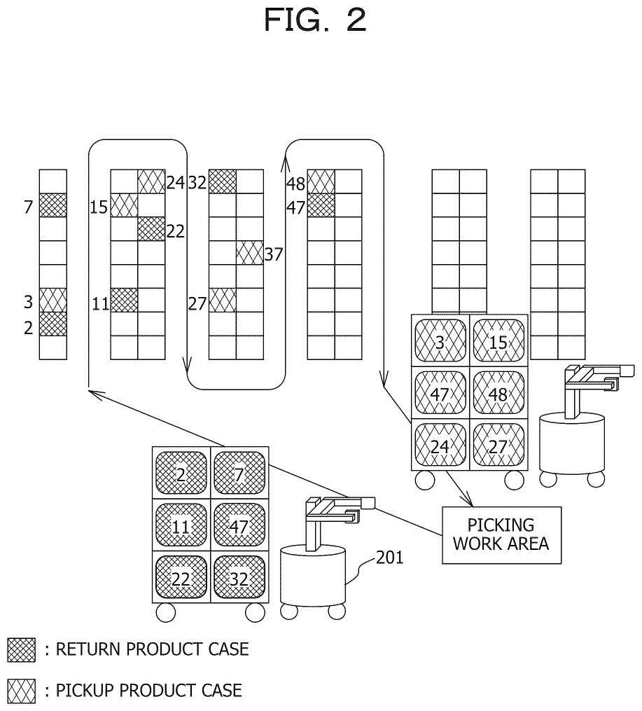

FIG. 2 is a diagram illustrating a picking work capable of efficiently performing the pickup work and the return work. In the example in FIG. 2, the traveling machine 201 can return the return product cases in the middle of the traveling route indicated by the arrows and pick up the pickup product cases in a placement space that has become empty. Thereafter, continuously, the traveling machine 201 can pick up the pickup product cases while returning the return product cases so as not to exceed the maximum number to be placed. In such a case, the traveling machine 201 can efficiently perform the picking work.

However, in-warehouse aisles are often one-way for reasons such as operation restriction to the traveling machine 201. Therefore, in a case where the product shelf of the pickup product case is located on a near side of the product shelf of the return product case in the traveling route, it is expected to bypass the aisle after finishing the return work and to come to the product shelf behind one more time to pick up the pickup product case, which produces extra travel. In addition, since the orders or the work situations may change in some cases, it is expected to prepare a plan in real time in accordance with the situation.

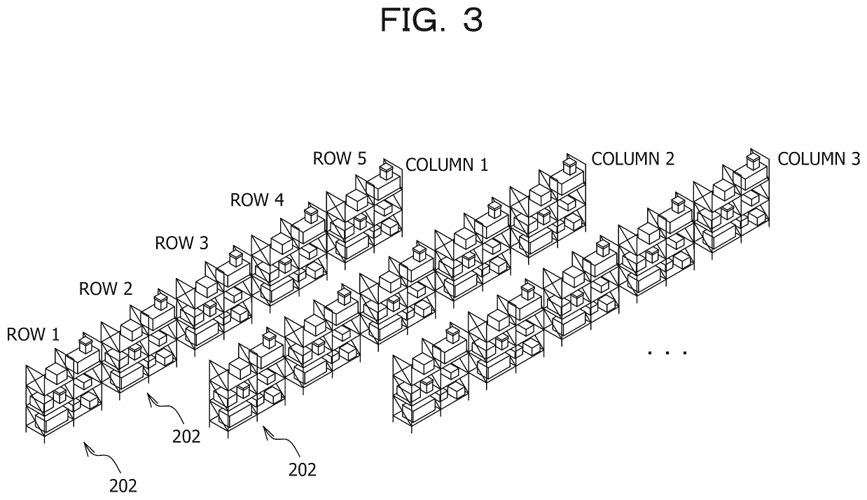

Here, the arrangement of the product shelves 202 in the warehouse will be described in detail. FIG. 3 is a perspective view of an inside of a warehouse. As illustrated in FIG. 3, the product shelves 202 in a plurality of rows (1, 2, 3, . . . ) are arranged in a plurality of columns (1, 2, 3, . . . ). For example, the position of each product shelf is defined by a matrix number=(row number, column number) having a column number and a row number, as an identifier. Each of the product shelves 202 contains a plurality of product cases. However, the number given to the product case contained in each product shelf 202 (hereinafter, a product number) is designated as an identifier. For example, the product numbers are designated such that the product cases with the product numbers=1 to 6 are contained in the product shelf 202 with the matrix number (1, 1), the product cases with the product numbers=7 to 12 are contained in the product shelf 202 with the matrix number (2, 1), and so forth. The product cases with the same product number contain products of the same type. The product cases with different product numbers contain products of different types.

By providing intervals between the columns, the traveling machine 201 is allowed to travel. A path formed by providing an interval between the columns will be hereinafter referred to as an aisle. In a case where no interval is provided between the columns, the traveling machine 201 is not allowed to travel. The traveling machine 201 does not go back in the middle of the aisle. For example, the traveling machine 201 does not go back after travelling halfway on the aisle between the columns 1 and 2. Note that the traveling machine 201 may reciprocate in the same aisle in one reciprocation, but in the following example, the traveling machine is assumed not to reciprocate in the same aisle in one reciprocation. For example, after the traveling machine 201 has finished traveling on the aisle between the columns 1 and 2, the traveling machine 201 does not return on the aisle, but returns through another aisle. However, in a case where the backward path is the path between the columns 1 and 2, it is acceptable to travel on the same aisle as the outward path of next reciprocation.

The traveling machine 201 is allowed to perform the return work and pickup work on the same product shelf. For example, the traveling machine 201 can return the product cases with the product numbers=1 to 3 and pick up the product cases with the product numbers=4 to 6 while stopping at the product shelf with the matrix number=(1, 1). Note that, in the example described here, the traveling machine 201 is assumed not to perform the work for the matrix number (1, 2) when performing the work on the product shelf with the matrix number (1, 1). However, it may be assumed that the product cases with the matrix numbers (1, 1) and (1, 2) are allowed to be picked up at one time of work without distinguishing between the odd column and the even column.

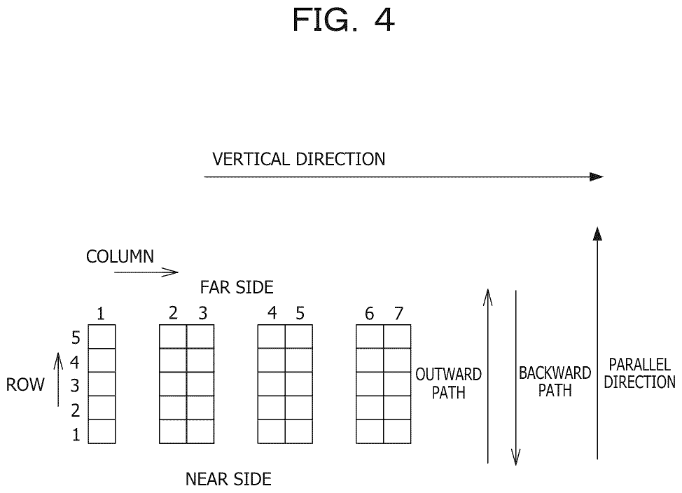

FIG. 4 is a diagram explaining a layout in a warehouse used in the following description. As illustrated in FIG. 4, an aisle is formed between the columns 1 and 2, no aisle is formed between the columns 2 and 3, and an aisle is formed between the columns 3 and 4. When expressed in a general formula, an aisle is formed between a column (2m−1) and a column (2m), and no aisle is formed between the column (2m) and a column (2m+1). In each column, a picking work area side (a side where the outward path is started) is assumed as a near side, and a side opposite to the picking work area (a side where the backward path is started) is assumed as a far side. A case where the traveling machine 201 travels to the far side from the near side is assumed as an outward path, and a case where the traveling machine 201 travels to the near side from the far side is assumed as a backward path.

As approaches for preparing a work plan in such a site, there are two types of optimization approaches. The first approach is an approach of lessening a total moving distance in a direction vertical to a component shelf (a direction vertical to a direction in which the aisle extends) when the inside of the warehouse is viewed in plan, and the second approach is an approach of lessening a total moving distance in a direction parallel to a component shelf (a direction parallel to a direction in which the aisle extends).

These approaches have different effects depending on situations such as the layout of the warehouse, distribution of components disposed on each component shelf, and order contents. Therefore, in order to prepare a highly effective plan, it is desirable to select an approach each time in accordance with the situation of the site. However, it is not practical in terms of operation to examine and apply a suitable approach each time in accordance with the layout or order. Alternatively, a method is conceivable in which the approaches are unified and efficient component arrangement and layout are prepared in accordance with the unified approaches and modified each time, but this also can be hardly deemed a practical operation method.

In the following embodiments, an information processing device, a method for preparing a work plan, and a work plan preparation program capable of preparing efficient pickup-return work will be described.

### First Embodiment

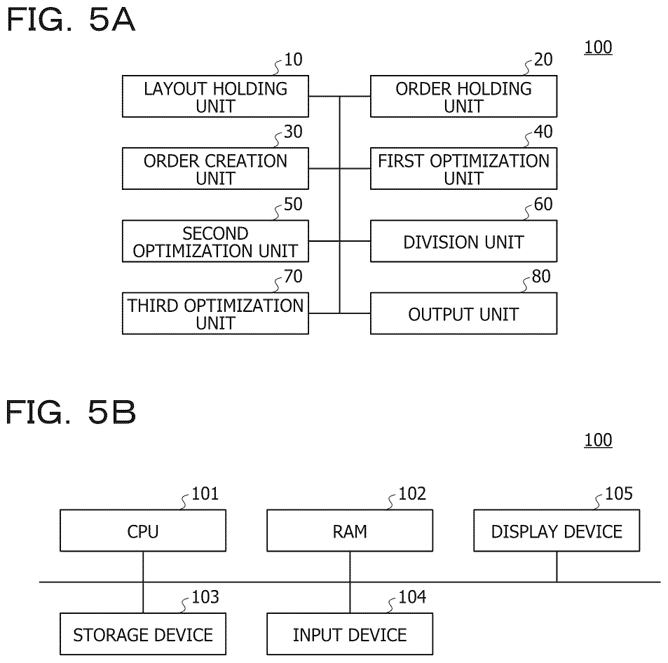

FIG. 5A is a block diagram illustrating an overall configuration of an information processing device 100. As illustrated in FIG. 5A, the information processing device 100 includes a layout holding unit 10, an order holding unit 20, an order creation unit 30, a first optimization unit 40, a second optimization unit 50, a division unit 60, a third optimization unit 70, an output unit 80, and the like.

FIG. 5B is a block diagram illustrating a hardware configuration of the information processing device 100. As illustrated in FIG. 5B, the information processing device 100 includes a central processing unit (CPU) 101, a random access memory (RAM) 102, a storage device 103, an input device 104, a display device 105, and the like.

The CPU 101 is a central processing unit. The CPU 101 includes one or more cores. The random access memory (RAM) 102 is a volatile memory that temporarily stores a program to be executed by the CPU 101, data to be processed by the CPU 101, and the like. The storage device 103 is a nonvolatile storage device. For example, a read only memory (ROM), a solid state drive (SSD) such as a flash memory, a hard disk to be driven by a hard disk drive, or the like can be used as the storage device 103. The storage device 103 stores the work plan preparation program. The input device 104 is an input device such as a keyboard or a mouse. The display device 105 is a display device such as a liquid crystal display (LCD). The layout holding unit 10, the order holding unit 20, the order creation unit 30, the first optimization unit 40, the second optimization unit 50, the division unit 60, the third optimization unit 70, and the output unit 80 are implemented by the CPU 101 executing the work plan preparation program. Note that hardware such as a dedicated circuit may be used as the layout holding unit 10, the order holding unit 20, the order creation unit 30, the first optimization unit 40, the second optimization unit 50, the division unit 60, the third optimization unit 70, and the output unit 80.

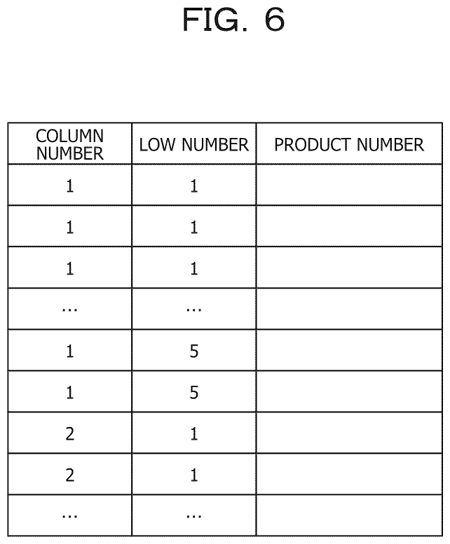

The layout holding unit 10 holds a layout of warehouse shelves. For example, as illustrated in FIG. 6, the layout holding unit 10 holds the product number of each product case and the matrix numbers of the product shelves in which each product case is contained, in association with each other.

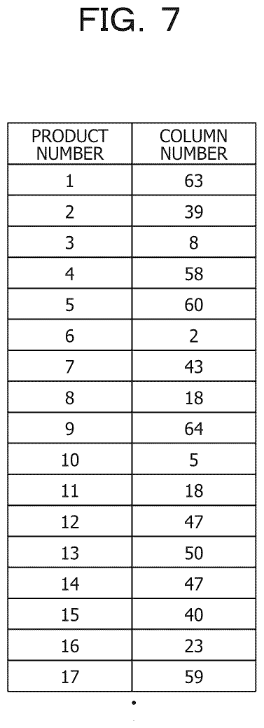

The order holding unit 20 holds an order input from the outside. FIG. 7 is a diagram illustrating orders. As illustrated in FIG. 7, in the orders, the product numbers to be picked are associated with the column numbers of the product shelves on which the product cases with each product number are arranged. Note that, since each product number is associated with the matrix number of one product shelf in the layout holding unit 10, only the product number may be designated in the order. In addition, in these orders, the sequential order of pickup has not yet been designated.

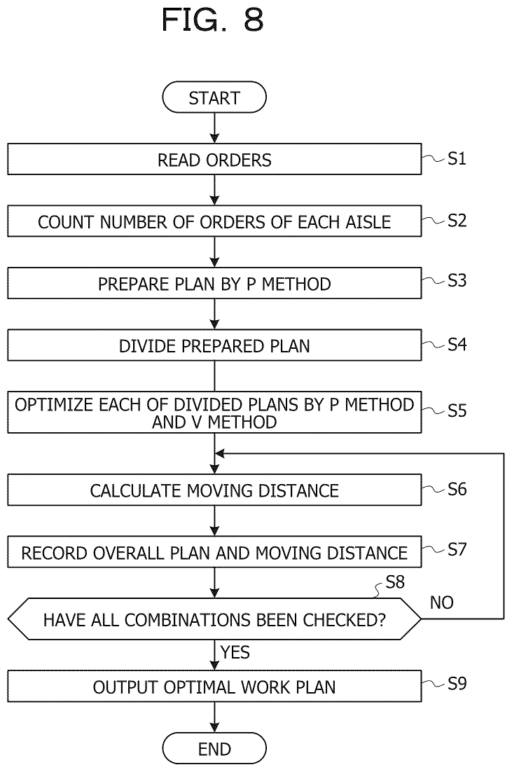

Hereinafter, details of processing executed by the information processing device 100 will be described. FIG. 8 is a flowchart representing an example of processing executed by the information processing device 100.

As illustrated in FIG. 8, the order creation unit 30 reads orders held in the order holding unit 20 (step S1).

Next, the order creation unit 30 refers to the orders read in step S1 and the layout held in the layout holding unit 10 to count the number of orders of each aisle (step S2).

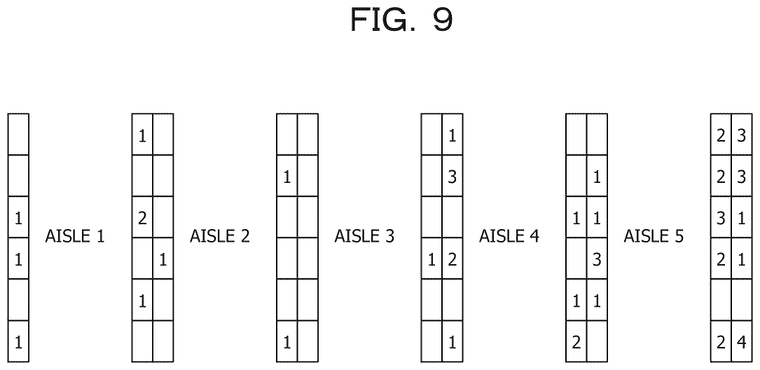

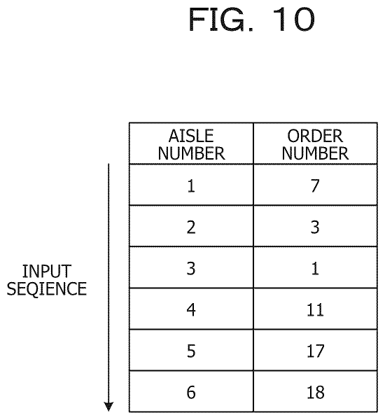

As illustrated in FIG. 9, the aisle between the column (2m−1) and the column (2m) will be referred to as an aisle m. Therefore, the aisle between the columns 1 and 2 is the aisle 1, the aisle between the columns 3 and 4 is the aisle 2, and the aisle between the columns 5 and 6 is the aisle 3. In addition, in FIG. 9, the number of product cases to be picked up or returned on each product shelf is mentioned for each product shelf. FIG. 10 is a diagram illustrating the number of orders counted. In the aisle 1, the number of product cases to be picked up or returned is seven. In the aisle 2, the number of product cases to be picked up or returned is three. The order creation unit 30 creates a sequence of the aisle numbers as priority ranking in pickup of the product cases. The initial sequence of the aisle numbers is not particularly limited, but in FIG. 10, the sequence is preassigned in ascending order of the aisle numbers.

Here, a V method that is an approach of lessening a total moving distance in a vertical direction and a P method that is an approach of lessening a total moving distance in a parallel direction will be described.

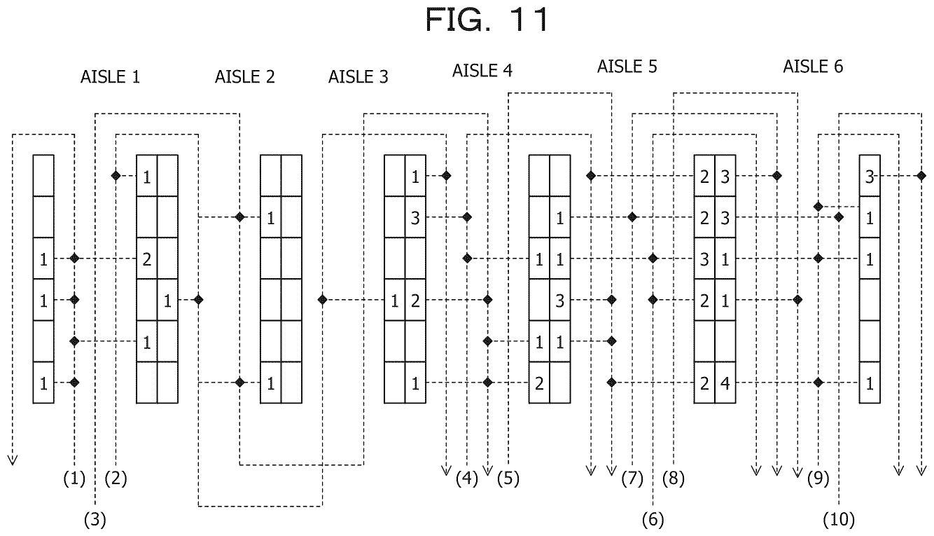

FIG. 11 is a diagram explaining the V method. In the V method, in order to lessen the total moving distance in the vertical direction, a plan is prepared to perform pickup-return work of orders located in the same aisle as much as possible at one time of work, along the sequence of aisle numbers.

For example, in a case where the sequence is preassigned in ascending order of aisle numbers, the work is prepared preferentially from the aisle 1. In the examples in FIGS. 9 and 10, the work from work (1) to work (10) is involved. The work (1) includes moving on the aisle 1 to pick up six product cases and returning. In the work (2), the product cases picked up in the work (1) are returned while moving on the aisle 1, and meanwhile, product cases are picked up on the aisle 2 as a backward path, product cases are picked up on the aisle 3 as an outward path, and product cases are picked up on the aisle 4 as a backward path.

In order to lessen the total moving distance in the vertical direction, the work (2) is adapted as a work having the aisle 1 as an outward path and having the aisle 2 as a backward path without skipping the aisle 2. This similarly applies also to the work (3) and the subsequent works. When the works (1) to (10) are summed, movement equal to 12 reciprocations in the parallel direction by 14 columns in the vertical direction is involved.

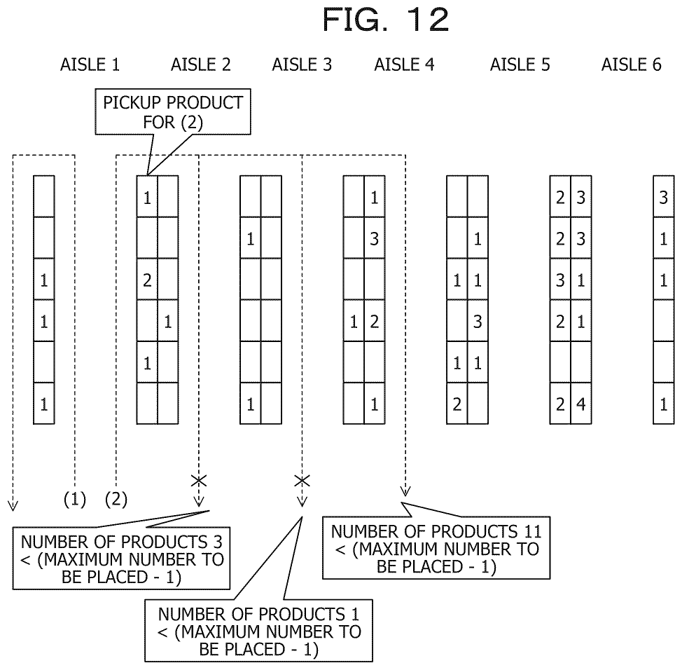

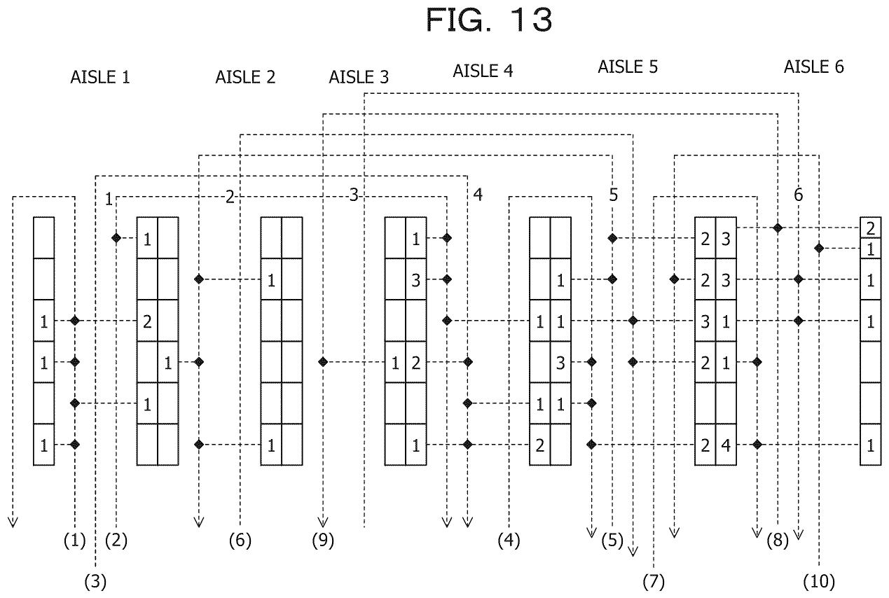

FIGS. 12 and 13 are diagrams explaining the P method. In the P method, in order to lessen a total moving distance in the parallel direction, a plan is prepared such that one time of pickup-return work is conducted in one reciprocating movement as much as possible, along the sequence of aisle numbers. In FIG. 12, preparation of the works (1) and (2) is illustrated.

Since the work (1) includes only going for pickup, the work is adapted to pick up six products on the aisle 1. For the work (2), the product cases picked up in the work (1) are returned while moving on the aisle 1. In addition, one product case is picked up on the aisle 1. Next, more product cases can be picked up in a case where the aisle 4 is employed as a backward path than in a case where the aisle 2 or 3 is employed as a backward path. Thus, in the work (2), the aisles 2 and 3 are skipped, and the aisle 4 is employed as the backward path. When prepared in this manner, movement equal to 10 reciprocations in the parallel direction by 22 columns in the vertical direction will be involved, as depicted in FIG. 13.

FIG. 8 is referred to again. After the execution of step S2, the first optimization unit 40 optimizes the work plan by the P method (step S3).

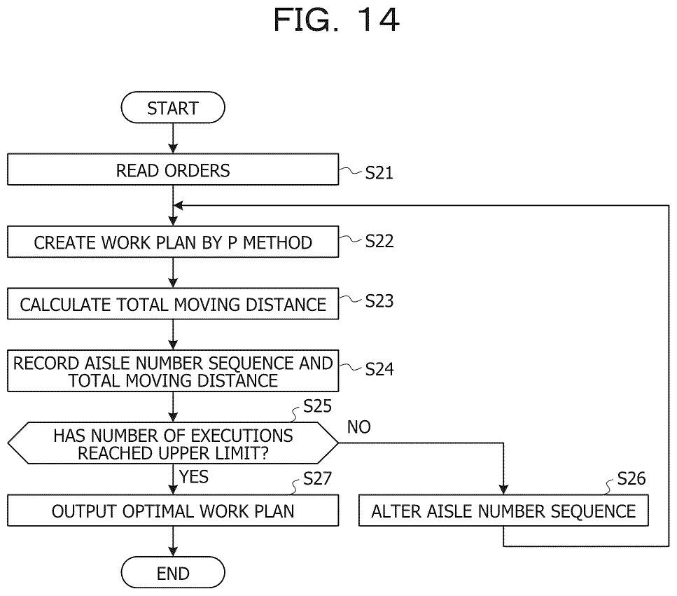

FIG. 14 is a flowchart representing details of step S3. As illustrated in FIG. 14, the first optimization unit 40 reads orders from the order holding unit 20 (step S21).

Next, the first optimization unit 40 creates a work plan by the P method, along the sequence of aisle numbers (step S22). Details of step S22 will be described later.

Next, the first optimization unit 40 calculates a total moving distance for the work plan created in step S22 (step S23).

Next, the first optimization unit 40 records the used aisle number sequence and the total moving distance from the result of step S23 (step S24).

Next, the first optimization unit 40 determines whether or not the number of executions from step S22 to step S24 has reached an upper limit (step S25).

When determining “No” in step S25, the first optimization unit 40 alters the sequence of aisle numbers (step S26). Thereafter, step S22 and the subsequent steps are again executed.

When determining “Yes” in step S25, the first optimization unit 40 outputs an optimal work plan among the work plans obtained by repeating steps S22 to S26 (step S27). The optimal work plan here is a work plan having the shortest total moving distance in the parallel direction.

Note that the optimization algorithm for the optimization computation part in steps S22 to S26 is not particularly limited, but is, for example, an evolutionary algorithm such as a genetic algorithm. These algorithms are used as optimization algorithms for altering the aisle number sequence.

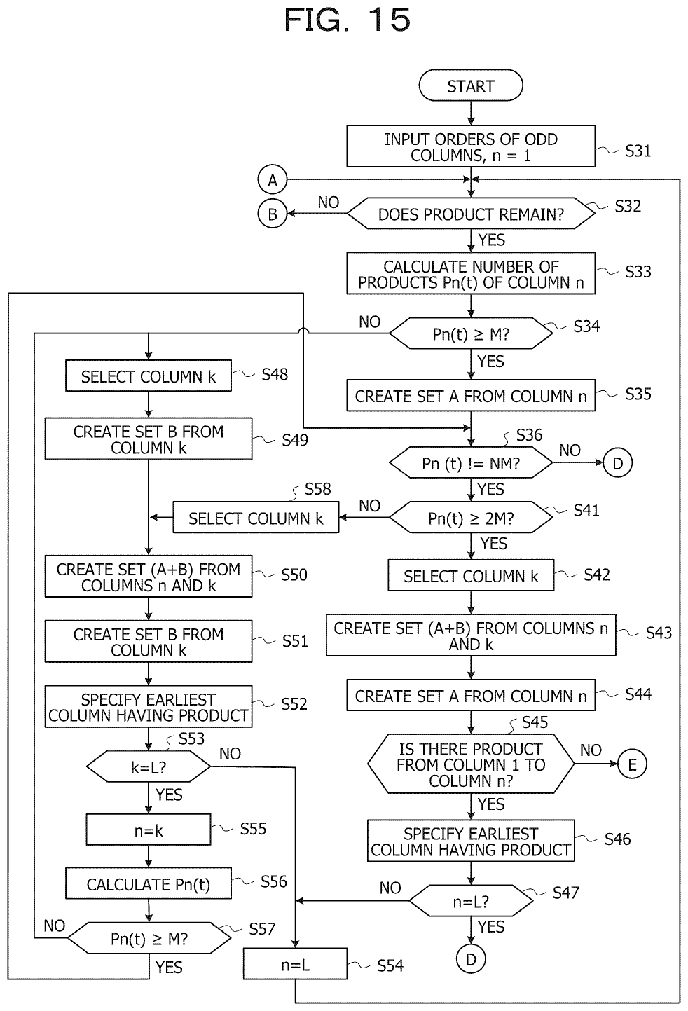

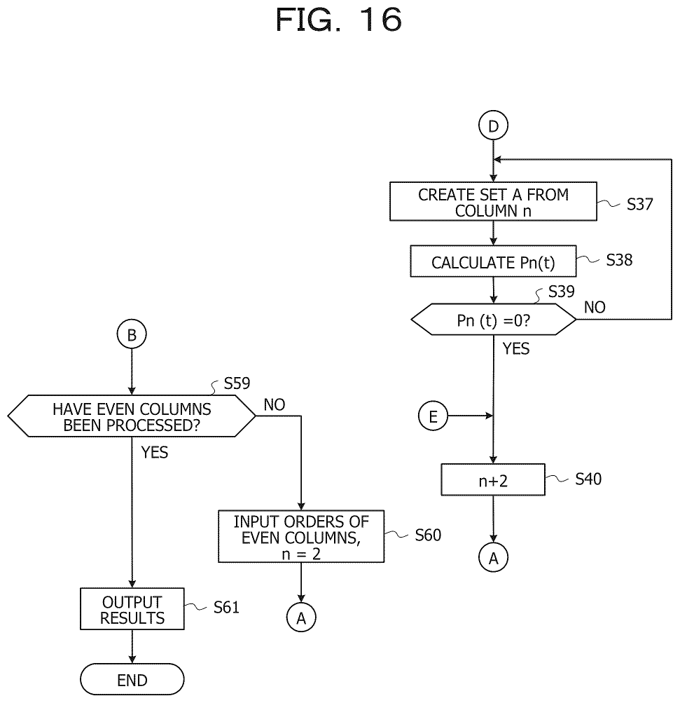

FIGS. 15 and 16 are flowcharts representing details of step S3. As illustrated in FIGS. 15 and 16, the first optimization unit 40 reads the orders of the odd columns and sets n=1 (step S31). Note that, in a case where the product cases in the odd columns and the even columns can be picked up at one time of work without distinguishing between the odd columns and the even columns, step S31 is not executed. Next, the first optimization unit 40 determines whether or not a product (product number) that has not been allocated to a work set remains (step S32). When step S32 is executed for the first time, “Yes” is determined in step S32 because no product has been allocated to the work set yet.

When determining “Yes” in step S32, the first optimization unit 40 calculates the number of products Pn(t) that have not yet been allocated, with a column n (step S33). The number of products corresponds to the number of product numbers. Next, the first optimization unit 40 determines whether or not the number of products Pn(t) is equal to or greater than the designated maximum number M to be placed (step S34).

When determining “Yes” in Step S34, the first optimization unit 40 creates, from the column n, a pickup set A for a single column A having M products from the products that have not yet been allocated to the work set (step S35).

Next, the first optimization unit 40 determines whether or not Pn(t)! is a natural number N times M (step S36). In step S36, it is verified whether or not the number of remaining products in the n column is a multiple of the maximum number M to be placed. In a case of a multiple, a set constituted by only the n column is repeatedly created in D. When determining “No” in step S36, the first optimization unit 40 creates the pickup set A for the single column A having M products from the products that have not been allocated yet, for the column n (step S37).

Next, the first optimization unit 40 calculates the number of products Pn(t) that have not been allocated yet (step S38). Next, the first optimization unit 40 determines whether or not Pn(t) calculated in step S38 has zero (step S39). In a case where “No” is determined in step S39, step S37 and the subsequent steps are again executed. When determining “Yes” in step S39, the first optimization unit 40 adds one to n (step S40). Thereafter, step S32 and the subsequent steps are again executed.

When determining “Yes” in step S36, the first optimization unit 40 determines whether or not the number of products Pn(t) is equal to or greater than 2M (step S41). When determining “Yes” is in step S41, the first optimization unit 40 selects a column k different from the column n (step S42). Next, the first optimization unit 40 creates a pickup set for two columns (A+B) from the columns n and k (step S43).

Next, the first optimization unit 40 creates the pickup set A for the single column A from the column n (step S44). Next, the first optimization unit 40 determines whether or not there is a product that has not been allocated yet from the column 1 to the column n (step S45). In a case where “No” is determined in step S45, step S40 is executed.

When determining “Yes” in step S45, the first optimization unit 40 specifies a column L having an earliest product (product number) that has not been allocated yet (step S46). Next, the first optimization unit 40 determines whether or not n=L is met (step S47). In a case where “Yes” is determined in step S47, step S37 is executed.

When determining “No” in step S34, the first optimization unit 40 selects the column k different from the column n (step S48). Next, the first optimization unit 40 creates a pickup set B for a single column B from the column k (step S49). Next, the first optimization unit 40 creates the pickup set (A+B) for two columns (A+B) from the columns n and k (step S50).

Next, the first optimization unit 40 creates the pickup set B for the single column B from the column k (step S51). Next, the first optimization unit 40 specifies the column L having an earliest product (product number) that has not been allocated yet (step S52). Next, the first optimization unit 40 determines whether or not k=L is met (step S53). In a case where “No” is determined in step S53, step S54 is executed. Also, in a case where “No” is determined in step S47, step S54 is executed.

When determining “Yes” in step S53, the first optimization unit 40 sets n=k (step S55). Next, the first optimization unit 40 calculates the number of products Pn(t) that have not allocated yet, for the column n (step S56). Next, the first optimization unit 40 determines whether or not the number of products Pn(t) is equal to or greater than M (step S57). In a case where “No” is determined in step S57, S48 is executed. In a case where “Yes” is determined in step S57, step S36 is executed.

When determining “No” in step S32, the first optimization unit 40 determines whether or not the even columns have been processed (whether the product numbers have been allocated) (step S59). When determining “No” in step S59, the first optimization unit 40 reads the orders of the even columns from the orders held in the order holding unit 20 and sets n=2 (step S60). Thereafter, step S32 and the subsequent steps are again executed. Note that, in a case where the odd columns and the even columns are not distinguished, the process proceeds to step S61 when “No” is determined in step S32. When determining “Yes” in step S39, the first optimization unit 40 outputs a creation result of each pickup set as a creation result of the work set (S61). Thereafter, the execution of the flowcharts ends.

FIG. 8 is referred to again. After the execution of step S3, the division unit 60 divides the work plan prepared in step S2 into a plurality of subplans (step S4). For example, the work plan in which the works (1) to (10) are sequentially performed is divided into a subplan of the works (1) to (3), a subplan of the works (4) to (6), and a subplan of the works (7) to (10) without losing the sequential order of the works.

Next, the first optimization unit 40 optimizes each subplan divided in step S4 by the P method, and the second optimization unit 50 optimizes each subplan by the V method (step S5). The optimization by the P method can be executed by the process in FIGS. 14 to 16. The optimization by the V method will be described below.

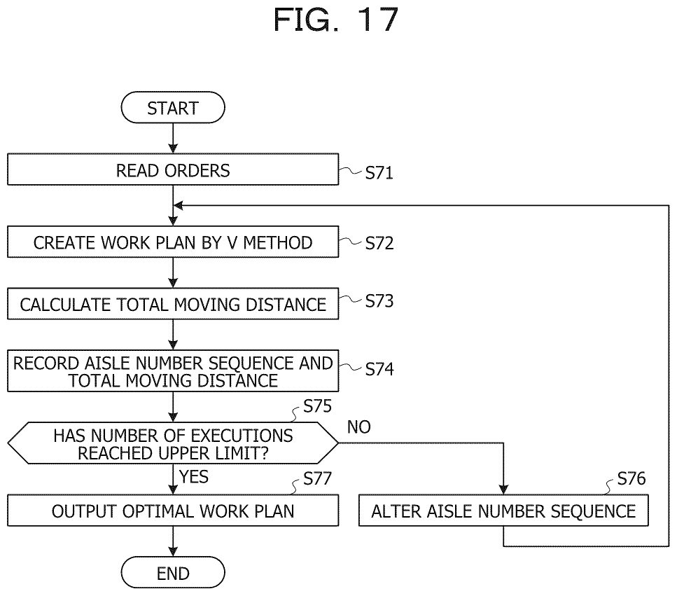

FIG. 17 is a flowchart representing details of optimization by the V method. As illustrated in FIG. 17, the second optimization unit 50 reads orders from the order holding unit 20 (step S71).

Next, the second optimization unit 50 creates a work plan by the V method, along the aisle number sequence (step S72). Details of step S72 will be described later.

Next, the second optimization unit 50 calculates a total moving distance for the work plan created in step S72 (step S73).

Next, the second optimization unit 50 records the aisle number sequence and the total moving distance from the result of step S73 (step S74).

Next, the second optimization unit 50 determines whether or not the number of executions from step S72 to step S74 has reached an upper limit (step S75).

In a case where “No” is determined in step S75, the sequence of aisle numbers is altered (step S76). Thereafter, step S72 and the subsequent steps are again executed.

When determining “Yes” in step S75, the second optimization unit 50 outputs an optimal work plan among the work plans obtained by repeating steps S72 to S76 (step S77). The optimal work plan here is a work plan having the shortest moving distance in the vertical direction.

Note that the optimization algorithm for the optimization computation part in steps S72 to S76 is not particularly limited, but is, for example, an evolutionary algorithm such as a genetic algorithm. These algorithms are used as optimization algorithms for altering the aisle number sequence.

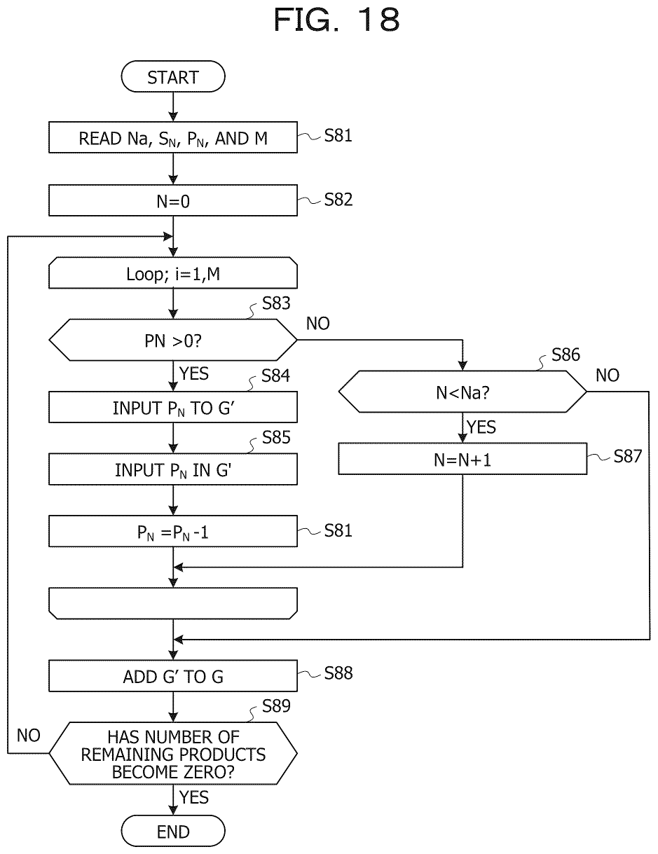

FIG. 18 is a flowchart representing details of step S72. As illustrated in FIG. 18, the second optimization unit 50 reads a maximum value Na of the aisle number, an order sequence S_{N}, a remaining product quantity P_{N} located in an aisle S_{N}, and the maximum number M to be placed in the traveling machine 201 (step S81). Note that the maximum value Na and the maximum number M to be placed are integers. The order sequence S_{N} and the remaining product quantity P_{N} are matrices. N denotes an integer.

Next, the second optimization unit 50 sets N to “0” (step S82).

Next, the second optimization unit 50 determines whether or not the remaining product quantity P_{N} exceeds zero (step S83). When determining “Yes” in step S83, the second optimization unit 50 inputs the remaining product quantity P_{N} to a combination G′ of aisles to be worked on at one time (step S84). The combination G′ is a matrix.

Next, the second optimization unit 50 subtracts one from the remaining product quantity P_{N} (step S85). Thereafter, step S83 and the subsequent steps are again executed.

When determining “No” in step S83, the second optimization unit 50 determines whether or not N is smaller than the maximum value Na (step S86).

When determining “Yes” in step S86, the second optimization unit 50 adds one to N (step S87). Thereafter, step S83 and the subsequent steps are again executed.

Steps S83 to S87 are a loop process and are repeated M times. However, in a case where “No” is determined in step S86, the loop process ends. In a case where step S83 has been repeated M times, the loop process ends after step S85 or S87 is executed.

After the loop process has ended, the second optimization unit 50 adds the combination G′ to a work plan G (step S88). Next, the second optimization unit 50 determines whether or not the number of remaining products has become zero (step S89). In a case where “No” is determined in step S89, the loop process from step S83 and the subsequent steps are again executed. In a case where “Yes” is determined in step S89, the execution of the flowchart ends.

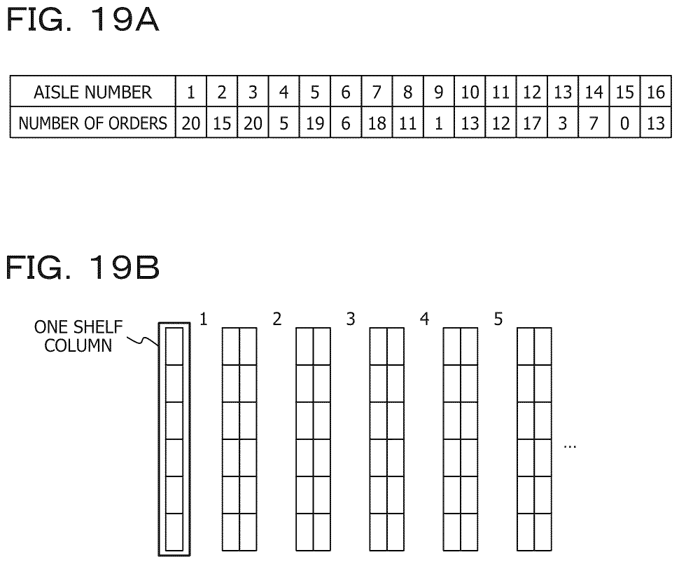

Subsequently, as an example, a moving distance involved in work of a total of 180 orders was calculated using the approach according to the present embodiment. As used data, distribution of orders existing in each aisle is illustrated in FIG. 19A. In addition, as illustrated in FIG. 19B, it was assumed that shelves in which components are accommodated are arranged at an interval of 1 m and the size per shelf column is 1 m wide and 15 m long.

As a result of optimizing the orders in FIG. 19A with one approach alone by each of the V method and the P method, the total moving distances relating to the work plan were 2358 m (the optimization result by the V method) and 2320 m (the optimization result by the P method), respectively. The total moving distance in the work plan before optimization was 2406 m, where the reduction rate by the V method was 3.9%, and the reduction rate by the P method was 7.0%.

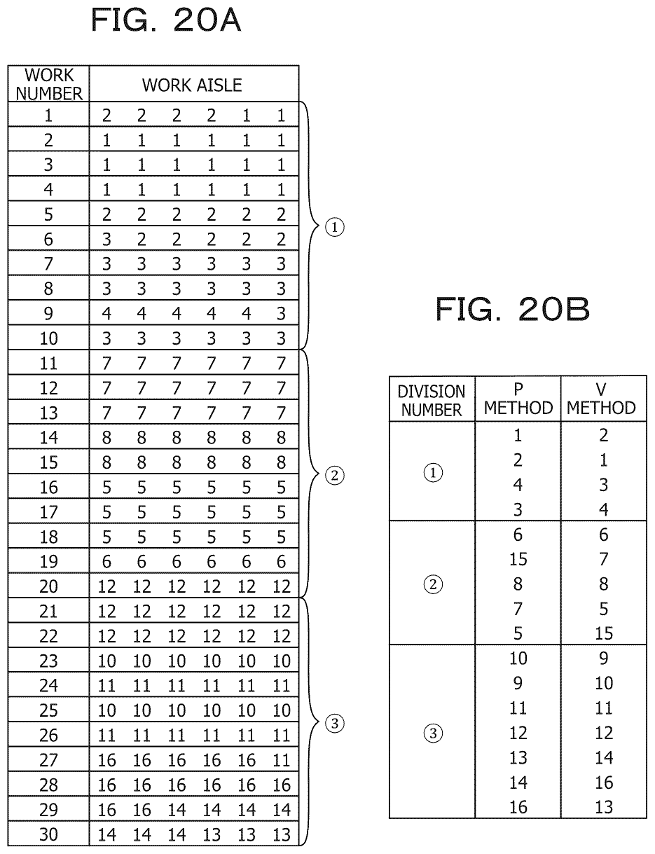

First, a work plan optimized by the P method is illustrated in FIG. 20A. At this time, the sequence of aisle numbers as an input variable was 1, 2, 3, 4, 7, 15, 8, 5, 6, 9, 10, 11, 12, 13, 14, and 16. At this time, the total moving distance was 2320 m.

Next, this work plan was divided into a subplan A “1, 2, 3, 4”, a subplan B “7, 15, 8, 5, 6”, and a subplan C “9, 10, 11, 12, 13, 14, 16”. In each of the subplans A to C, optimization was carried out separately using both the approaches of the P method and the V method so as to make the total moving distance shortest. FIG. 20B illustrates a result of the aisle number sequences optimized by each approach.

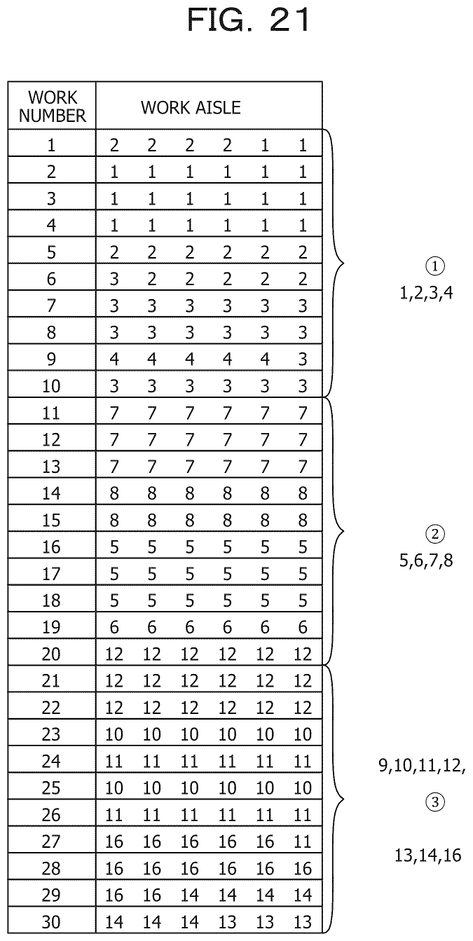

FIG. 21 is a diagram for explaining a preferable example of division of the work plan. The work plan preferably satisfies the following two conditions.

The first condition is that the dividing position is set at a unit delimiter when a plan is created by the P method. FIG. 21 indicates delimiters between work units in this case. The units are groups including each work number obtained in the course of preparing a plan such that one time of pickup-return work can be finished in one reciprocation. Even if the units are exchanged with each other, all the works can be finished in one reciprocation, and additionally, the sequential order of work numbers can also be reversed in the unit.

The second condition is that orders each located in the same aisle are all included in the divided group. The aisle numbers of the orders included in each of the divided subplans A to C are indicated on the right of FIG. 21.

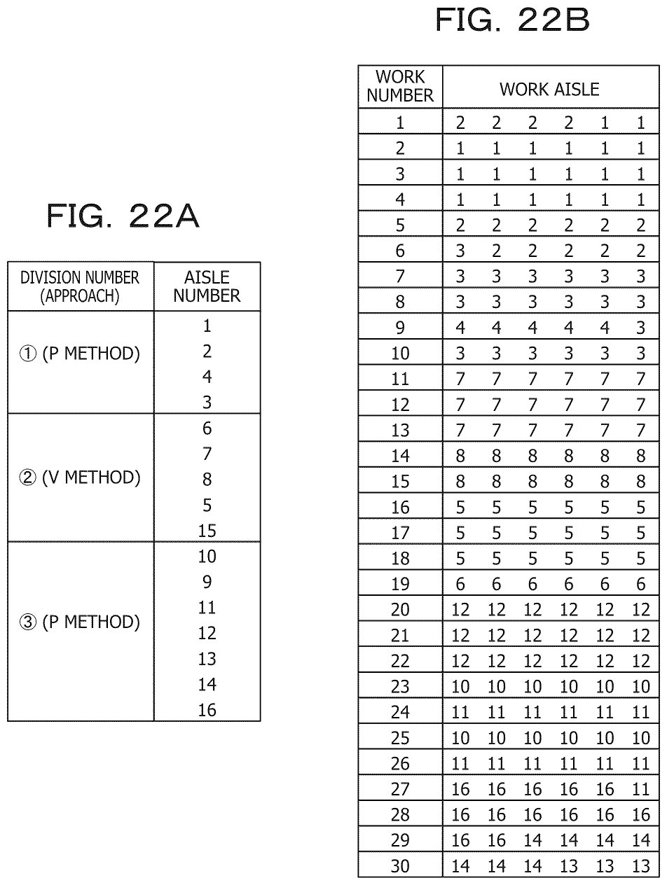

FIG. 22A illustrates a result of optimizing combinations of the aisle number sequence groups so as to minimize the total moving distance. The obtained work plan is illustrated in FIG. 22B. The total moving distance in this plan was 2314 m, and a plan was prepared in which the total moving distance was further reduced by 0.5% as compared with the P method.

In the above example, the work plan obtained by optimization by the P method is divided into a plurality of subplans, but this is not restrictive. For example, the work plan obtained by optimization by the V method may be divided into a plurality of subplans.

According to the present embodiment, either the optimization by the P method or the optimization by the V method is executed. The obtained work plan is divided into a plurality of subplans, and both of the optimization by the P method and the optimization by the V method are executed on each of the plurality of subplans. The work plan is prepared by combining the optimization results of the plurality of subplans. According to such a configuration, more efficient pickup-return work may be prepared as compared with a case where either the P method or the V method is executed alone.

In the above example, the product case is an example of an article. The product shelf is an example of an article shelf. The product number of each product case is an example of an identifier for specifying an article shelf in which the product case is contained. The traveling machine 201 is an example of a moving body. The pickup of the product case is an example of a first work of placing a plurality of first articles specified by the identifiers on the moving body from the article shelves. The return of the product case is an example of a second work of placing a plurality of second articles placed on the moving body on the article shelves specified by the identifiers assigned to the articles. The P method is an example of a first search of searching for the work plan so as to decrease the total moving distance in a direction in which the aisles extend. The V method is an example of a second search of searching for the work plan so as to decrease the total moving distance between the plurality of columns.

The division unit 60 is an example of a division unit that divides a work plan obtained by executing either the first search or the second search on the work plan in which the moving body performs the first work and the second work on the articles designated from among the plurality of articles, into a plurality of subplans. The first optimization unit 40 and the second optimization unit 50 are examples of an execution unit that executes both of the first search and the second search on each of the plurality of subplans. The third optimization unit 70 is an example of a preparation unit that prepares the work plan by combining results of the first search and the second search for the plurality of subplans.

While the embodiments have been described above in detail, the embodiments are not limited to such particular embodiments, and various modifications and alterations can be made within the scope of the gist of the embodiments described in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a work plan preparation program for causing a computer to execute a process comprising:
under a condition regarding a plurality of articles, a plurality of columns that each include a plurality of article shelves, and a plurality of aisles provided between the plurality of columns, in which identifiers that indicate correspondence relationships between each of the plurality of articles and each of the plurality of article shelves are assigned, and a moving body that has a placement space intended to place the articles moves on any of the plurality of aisles as an outward path, moves any aisle of the plurality of aisles as a backward path, and performs at least one of a first work of placing a plurality of first articles specified by the identifiers on the moving body from the article shelves, and a second work of placing a plurality of second articles placed on the moving body on the article shelves specified by the identifiers assigned to the second articles,
executing, on a work plan in which the moving body performs the first work and the second work on the articles designated from among the plurality of articles, either a first search of searching for the work plan so as to decrease a total moving distance in a direction in which the aisles extend or a second search of searching for the work plan so as to decrease the total moving distance between the plurality of columns, and dividing the work plan found in the search into a plurality of subplans;
executing both of the first search and the second search on each of the plurality of subplans; and
preparing the work plan by combining results of the first search and the second search for the plurality of subplans.

2. The non-transitory computer-readable recording medium according to claim 1, wherein the plurality of subplans has, as a delimiter, a work unit that allows the second work to be performed and the first work to be performed with one movement on the outward path and one movement on the backward path.

3. The non-transitory computer-readable recording medium according to claim 1, wherein an upper limit is predetermined for a number of the articles that are allowed to be simultaneously placed in the placement space.

4. The non-transitory computer-readable recording medium according to claim 1, wherein under the condition, the plurality of articles is contained in each of the article shelves, and both of the first work and the second work are allowed to be performed on a same one of the article shelves.

5. The non-transitory computer-readable recording medium according to claim 1, wherein under the condition, the articles are product cases that contain a plurality of products of same types.

6. A method for preparing a work plan for causing a computer to execute a process comprising:
under a condition regarding a plurality of articles, a plurality of columns that each include a plurality of article shelves, and a plurality of aisles provided between the plurality of columns, in which identifiers that indicate correspondence relationships between each of the plurality of articles and each of the plurality of article shelves are assigned, and a moving body that has a placement space intended to place the articles moves on any of the plurality of aisles as an outward path, moves any aisle of the plurality of aisles as a backward path, and performs at least one of a first work of placing a plurality of first articles specified by the identifiers on the moving body from the article shelves, and a second work of placing a plurality of second articles placed on the moving body on the article shelves specified by the identifiers assigned to the second articles,
executing, on a work plan in which the moving body performs the first work and the second work on the articles designated from among the plurality of articles, either a first search of searching for the work plan so as to decrease a total moving distance in a direction in which the aisles extend or a second search of searching for the work plan so as to decrease the total moving distance between the plurality of columns, and dividing the work plan found in the search into a plurality of subplans;
executing both of the first search and the second search on each of the plurality of subplans; and
preparing the work plan by combining results of the first search and the second search for the plurality of subplans.

7. The method according to claim 6, wherein the plurality of subplans has, as a delimiter, a work unit that allows the second work to be performed and the first work to be performed with one movement on the outward path and one movement on the backward path.

8. The method according to claim 6, wherein an upper limit is predetermined for a number of the articles that are allowed to be simultaneously placed in the placement space.

9. The method according to claim 6, wherein under the condition, the plurality of articles is contained in each of the article shelves, and both of the first work and the second work are allowed to be performed on a same one of the article shelves.

10. The method according to claim 6, wherein under the condition, the articles are product cases that contain a plurality of products of same types.

11. An information processing device comprising:
a memory; and
a processor coupled to the memory and configured to:
under a condition regarding a plurality of articles, a plurality of columns that each include a plurality of article shelves, and a plurality of aisles provided between the plurality of columns, in which identifiers that indicate correspondence relationships between each of the plurality of articles and each of the plurality of article shelves are assigned, and a moving body that has a placement space intended to place the articles moves on any of the plurality of aisles as an outward path, moves any aisle of the plurality of aisles as a backward path, and performs at least one of a first work of placing a plurality of first articles specified by the identifiers on the moving body from the article shelves, and a second work of placing a plurality of second articles placed on the moving body on the article shelves specified by the identifiers assigned to the second articles, execute, on a work plan in which the moving body performs the first work and the second work on the articles designated from among the plurality of articles, either a first search of searching for the work plan so as to decrease a total moving distance in a direction in which the aisles extend or a second search of searching for the work plan so as to decrease the total moving distance between the plurality of columns;
divide the work plan found in the search into a plurality of subplans;
execute both of the first search and the second search on each of the plurality of subplans; and
prepare the work plan by combining results of the first search and the second search for the plurality of subplans.

12. The information processing device according to claim 11, wherein the plurality of subplans has, as a delimiter, a work unit that allows the second work to be performed and the first work to be performed with one movement on the outward path and one movement on the backward path.

13. The information processing device according to claim 11, wherein an upper limit is predetermined for a number of the articles that are allowed to be simultaneously placed in the placement space.

14. The information processing device according to claim 11, wherein under the condition, the plurality of articles is contained in each of the article shelves, and both of the first work and the second work are allowed to be performed on a same one of the article shelves.

15. The information processing device according to claim 11, wherein under the condition, the articles are product cases that contain a plurality of products of same types.
